(19) United States
(12) Patent Application Publication
(10) Pub. No.: US 2019/0196484 A1
(43) Pub. Date: Jun. 27, 2019

(54) System for controlling a self-driving vehicle controllable on the basis of control values and acceleration values, self-driving vehicle provided with a system of this type and method for training a system of this type.

(71) Applicants: Stephan Johannes Smit, Utrecht (NL); Johannes Wilhelmus Maria van Bentum, Utrecht (NL)

(72) Inventors: Stephan Johannes Smit, Utrecht (NL); Johannes Wilhelmus Maria van Bentum, Utrecht (NL)

(21) Appl. No.: 16/163,315

(22) Filed: Oct. 17, 2018

(30) Foreign Application Priority Data
Oct. 18, 2017 (NL) 2019756

(51) Int. Cl. G05D 1/02; G06K 9/00; G06K 9/62; G05D 1/00; G06N 20/00

(52) U.S. Cl. CPC G05D 1/0221; G06K 9/00791; G06K 9/6202; G06K 9/6257; G05D 1/0088; G05D 2201/0213; G05D 1/0246; G05D 1/0278; G06N 20/00; G06K 2009/6213; G05D 1/0223

(57) ABSTRACT

A system for controlling a self-driving vehicle controllable on the basis of direction values and acceleration values, comprising a navigation module, a control module and a camera wherein the navigation module is configured to plan a route, on the basis of a received destination, via a series of previously received navigation points and to convert the route into navigation instructions and to supply the latter at a navigation point to the control module, wherein the control module is configured to receive navigation instructions and to receive live camera images and can compare the latter with previously stored camera images annotated with at least navigation points and to convert the navigation instructions and the camera images into direction values and acceleration values for the controllable self-driving vehicle and to determine that a navigation point has been reached if a live camera image has a predefined degree of correspondence with a camera image annotated with a navigation point, and to report to the navigation module that the navigation point has been reached.

The present invention relates to a system for controlling a self-driving vehicle controllable on the basis of control values and acceleration values and a method for training a system of this type.

Unmanned and, in particular, self-driving vehicles are increasingly used for baggage and parcel transport. They can easily be used in enclosed spaces such as distribution centres or in other logistics applications, such as at airports, where the environment is strictly controlled and/or predictable. Fixed routes which are not subject to unpredictable changes can normally be driven in such situations.

A different situation arises when self-driving vehicles are used in public spaces or on public roads. Although the actual route to be driven is mainly unchanged in the short or medium term in these situations also, environmental factors and, in particular, fellow road users on public roads, give rise to unpredictable situations. It is known for regularly updated and very detailed high-resolution maps to be used here, along with sensors for detecting fellow road users, but a satisfactory result has hitherto not been achieved therewith, particularly since the volume of data required to provide maps with a sufficient level of detail is unacceptably high in practice. In addition, although obstacles can be detected by means of the sensors, a subsequent difficulty lies in determining the necessary response.

### BRIEF DESCRIPTION OF THE DRAWINGS

FIG. 1 is a flow diagram showing a system for controlling a self-driving vehicle controllable on the basis of control values and acceleration values.

### DESCRIPTION OF THE INVENTION

One object of the present invention is therefore to provide a system for controlling a self-driving vehicle which does not have the aforementioned disadvantages. A further object of the present invention is to provide a vehicle equipped with a system of this type and another further object of the present invention is to provide a method for training a system of this type.

For this purpose, the invention relates to a system for controlling a self-driving vehicle controllable on the basis of control values and acceleration values, comprising a navigation module, a control module, at least one camera and a recognition module,

wherein the navigation module is configured to receive a destination, chosen from a closed list of destinations, from a user, to determine a position of the vehicle, to determine a route from the position to the destination, to convert the route into navigation instructions, to supply the navigation instructions to the control module, to receive a recognition confirmation from the recognition module if a navigation point, wherein the camera is configured to capture live camera images from the vehicle and to supply the images to the control module and the recognition module, wherein the control module is configured to receive at least one navigation instruction from the navigation module, to receive the live camera images from the camera; and to convert the at least one navigation instruction and the camera images into control values and acceleration values for the controllable self-driving vehicle, and wherein the recognition module is configured to compare the live camera images with previously stored camera images annotated with at least characteristics of navigation points, and to determine that a navigation point has been reached if a live camera image has a predefined degree of correspondence with a camera image annotated with a navigation point, and to supply a recognition confirmation to the navigation module if it is determined that a navigation point has been reached.

The self-driving vehicle according to the invention is intended and configured for unmanned driving and, for example, for the “last mile” during the transport of parcels, baggage and other small business consignments, food distribution, message delivery and/or disposal of waste materials, and is preferably propelled by a non-CO2-emitting fuel source such as an electric drive or a drive with a fuel cell.

The system according to the present invention offers various advantages. First of all, the need for the use of detailed maps is eliminated through the use of navigation points and the comparison of camera images with previously stored images. The system in fact makes it possible to move from one navigation point to another on the basis of a relatively rough location indication, wherein the arrival at the exact location is determined through the comparison of camera images. An additional advantage is that, as a result, there is also no need to have positioning technology, such as GPS, whereby the system makes it possible to operate without receiving external reference signals.

The navigation instructions preferably comprise at least one direction indication, such as an exact geographical direction indication (in degrees), and geographical direction designation (such as “to the north”) and/or specific direction indication (such as “off to the left”). On the basis thereof and on the basis of the received camera images, the control module can determine a control outcome with which the vehicle follows the intended direction indication.

The instructions may be in the form of a list, wherein a navigation point is designated in each case with at least one direction to be followed from that point. More preferably, the navigation instructions also comprise a speed indication which indicates, for example, the maximum speed applicable from the relevant navigation point in the indicated direction.

The system can therefore be configured in such a way that the navigation instructions are processed by the control module as target values or desired values which impose a maximum speed. The nature and circumstances of the route may give cause to maintain a speed which is lower than the target value.

It should be noted that, in a further preferred embodiment of the present invention, the live camera images and the previously stored camera images annotated with at least navigation points are compared after preprocessing, wherein recognition points determined in the live camera images, rather than the complete camera images, are compared with recognition points determined in the previously stored camera images. These recognition points are applied by algorithms used in the preprocessing and may, for example, be (combinations of) horizontal and vertical lines, or other characteristics preferably independent from the weather conditions and the time of day.

The navigation module is further preferably configured to supply a subsequent navigation instruction to the control module as soon as the recognition module has reported that a navigation point has been reached. In this way, the control module does not have to store a complete route, but in each case must always formulate control values and acceleration values to one navigation point.

In a further embodiment, the control module is configured to determine a way to convert the navigation instructions into direction values and acceleration values for the controllable self-driving on the basis of deep learning. Here, a route to be driven or an area to be driven is driven at least once, but preferably several times, wherein camera images are recorded which are processed by the control module. The module recognizes patterns in the images, for example distances to kerbs, white lines on the road, traffic signs, exits and the direction values and acceleration values given by the user thereto. After having been trained in this way, the system can itself generate direction values and acceleration values on the basis of video images.

A user who trains the control module can mark the navigation points. By making different choices at different times (such as the first time “off to the left” and the second time “off to the right”) in the case of specific navigation points, such as intersections, the system learns that there are different possibilities at a location of this type, and also learns the direction values and acceleration values associated with the different choices. By also recording the relevant choice (for example turning “off to the left” or “off to the right”), the system can then perform an entered navigation instruction which corresponds to a choice of this type.

The deep learning technique is known per se and existing technologies can be used for the implementation thereof. A tried and tested system which appears to be suitable for the present invention is commercially available as Nvidia Dave 2 network topology.

Systems of this type offer a technology which enables a vehicle to demonstrate specifically learnt road users' behaviour, wherein vehicles remain independently on the road. By using navigation points and (visually) recognizing them, the present invention adds a navigation facility. The system thus uses technology existing per se to follow a route, but, as it recognizes the choice options, particularly at navigation points, it can follow instructions having a level of abstraction of “the second turn to the left”, on the basis of camera images and without the location of the choice option having to be clear in advance.

The navigation instructions always apply from one navigation point to another and are therefore generated and forwarded at a relatively low frequency, depending on the distance between the navigation points. In order to be able to react appropriately to quickly changing traffic situations, the control module is preferably configured to provide control values and/or acceleration values at a frequency of at least 10 Hz, applied at a speed of a few kilometres per hour. This frequency can be chosen as higher in the case of a higher vehicle speed.

The system according to the present invention can optionally be implemented with a GPS system to recognize error situations. It can thus be determined, for example, whether the vehicle has more than one expected deviation from a navigation point when it is en route, and it can be concluded that an error has occurred. The system can be configured to issue an error message at such a time and send it to a central monitoring facility such as a traffic management centre or a monitoring room.

The system can furthermore be used in various traffic situations or circumstances by being trained in all these situations and by recording associated adaptations in driving behaviour. In this way, it can be configured, for example, to reduce speed on the basis of obstacles, weather conditions, illumination or quality of the road surface. The training can be defined on the basis of images and other data in the real world but also through interaction with virtual worlds in simulation.

The invention furthermore relates to a method for training a system according to one of the preceding claims, comprising the steps of: A. Driving of at least one autonomously drivable route by a driver with the controllable self-driving vehicle, B. Recording camera images of the route during the driving, C. Storing navigation points in relation to the camera images, and D. Annotating the navigation points with coordinates for the navigation module. It is similarly conceivable for a system to be trained to drive routes entirely in simulation. The simulations are partially fed by images recorded in the real world. These may be images of different routes.

In order to be able to train the system, the vehicle must be controllable and must be controlled by a driver who also drives at least one intended autonomously drivable route, or also drives in an area in which a plurality of routes are located. It may be that the driver is present in or on or near the vehicle, but it is preferable to configure the system in such a way that it is remotely operable and therefore trainable also. During the driving, the driver himself always provides control values and acceleration values which are linked by the system to camera images of the route recorded during the driving. In this way, the system learns which control values and acceleration values belong to which street or road layout and can generate the associated direction values and acceleration values following the training on the basis of live images. By repeatedly revisiting the navigation points for which a plurality of options (for example turn-offs) exist in the training and making different choices.

According to one preferred embodiment of the method according to the present invention, the camera images are recorded in a form preprocessed for image recognition. Instead of storing the entire image stream, characteristics from the image which are relevant to image recognition and/or location recognition are thus defined. Combinations of horizontal and vertical lines in the image, large areas or characteristic shapes can be envisaged here.

In order to eliminate the dependence on changing conditions, such as the time of day, the weather and/or the traffic density, the method according to the invention preferably comprises the repetition of step A. under different weather conditions and/or traffic conditions. The system learns to recognize the weather conditions and traffic conditions, and also the manner in which to react thereto. The camera images recorded during the training can then be processed offline, wherein, for example, they are preprocessed for image recognition, and/or a timestamp, steering angle and/or acceleration value is/are linked to the images.

In a more advanced system according to the invention, the system is configured to train one system on the basis of the camera images recorded by one or more systems of the same type. In this way, a self-learning system is created, and each vehicle does not have to be independently trained.

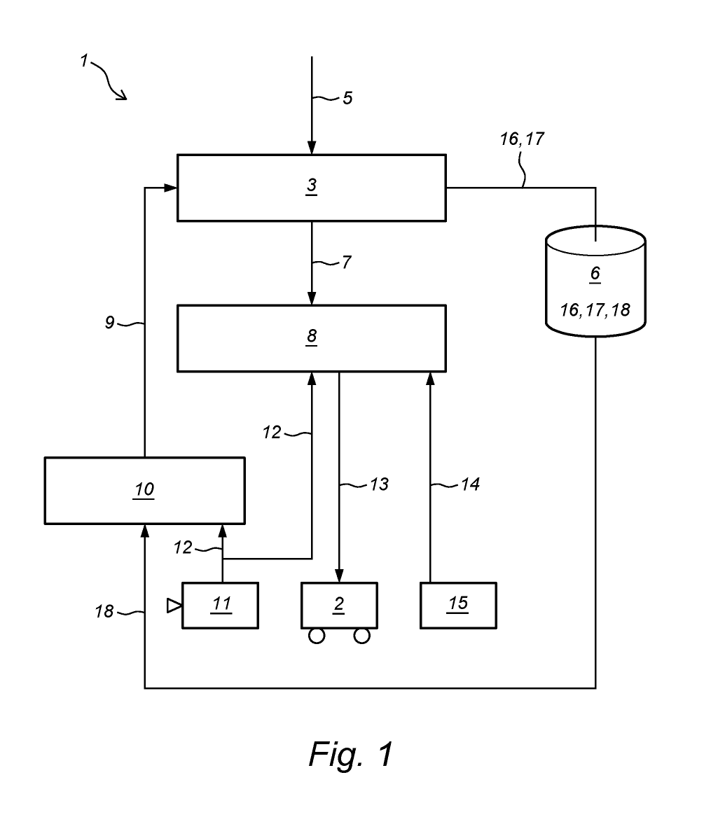

The invention will now be explained with reference to FIG. 1, which provides a schematic representation of a system according to the present invention.

FIG. 1 shows a system 1 for controlling a self-driving vehicle 2 controllable on the basis of control values and acceleration values, comprising a navigation module 3 which is configured to receive a destination 5, chosen from a closed list of destinations 16 stored in a data storage device 6, from a user, and to determine a position of the vehicle, for example by recording the last-known location 17 in the data storage device 6, to determine a route from the position to the destination, wherein said route can similarly be chosen from a list of possible routes which are similarly stored in the data storage device 6, to convert the route into navigation instructions, to supply the navigation instructions 7 to a control module 8, and to receive a recognition confirmation 9 from a recognition module 10. The system furthermore comprises a camera 11 which is configured to capture live camera images 12 from the vehicle 2 and to supply the images to the control module 8 and the recognition module 10. The control module 8 is furthermore configured to receive at least one navigation instruction 7 from the navigation module 3 and to receive the live camera images 12 from the camera 11 and to convert the at least one navigation instruction 7 and the camera images 12 into control values and acceleration values 13 for the controllable self-driving vehicle 2. In the embodiment shown, the control module 8 similarly makes use of an acceleration signal 14 obtained from an acceleration sensor 15. Finally, the recognition module 10 is configured to compare the live camera images 12 with previously stored camera images annotated with at least characteristics 18 of navigation points, and to determine that a navigation point has been reached if a live camera image 12 has a predefined degree of correspondence with a camera image 18 annotated with a navigation point, and to supply a recognition confirmation 9 to the navigation module if it is determined that a navigation point has been reached.

Along with the aforementioned example, many embodiments fall within the protective scope of the present application, as set out in the following claims.

1. System for controlling a self-driving vehicle controllable on the basis of control values and acceleration values, comprising:
a navigation module;
a control module;
at least one camera;
a recognition module;
wherein the navigation module is configured:
to receive a destination, chosen from a closed list of destinations, from a user;
to determine a position of the vehicle;
to determine a route from the position to the destination;
to convert the route into navigation instructions;
to supply the navigation instructions to the control module;
to receive a recognition confirmation from the recognition module;
wherein the camera is configured:
to capture live camera images from the vehicle and to supply the images to the control module and the recognition module;
wherein the control module is configured:
to receive at least one navigation instruction from the navigation module;
to receive the live camera images from the camera;
to convert the at least one navigation instruction and the camera images into control values and acceleration values for the controllable self-driving vehicle;
wherein the recognition module is configured:
to receive live camera images;
to compare the live camera images with previously stored camera images annotated with at least characteristics of navigation points;
to determine that a navigation point has been reached if a live camera image has a predefined degree of correspondence with a camera image annotated with a navigation point; and
to supply a recognition confirmation to the navigation module if it is determined that a navigation point has been reached.

2. System according to claim 1, wherein:
the navigation module is configured to convert the destination received from the user into direction instructions, such as:
an exact geographical direction indication (in degrees),
a geographical direction (such as “to the north”); and/or
a specific direction indication (such as “off to the left”); and wherein
the control module is configured to receive the direction instructions and to convert the direction instructions into control values and acceleration values.

3. System according to claim 1, configured to compare the live camera images and the previously stored camera images annotated with at least navigation points after a preprocessing step, wherein recognition points determined in the live camera images, rather than the complete camera images, are compared with recognition points determined in the previously stored camera images.

4. System according to claim 1, wherein the navigation module is configured to supply a subsequent navigation instruction to the control module as soon as the recognition module has reported that a navigation point has been reached.

5. System according to claim 1, wherein the control module is configured to determine a way to convert the navigation instructions into direction values and acceleration values for the controllable self-driving on the basis of deep learning.

6. System according to claim 4, wherein the control module is provided with a Nvidia Dave 2 network topology for the deep learning.

7. System according to claim 1, wherein the control module is configured to provide direction instructions and acceleration instructions at a frequency of at least 10 Hz.

8. System according to claim 1, further comprising a GPS system to recognize error situations.

9. System according to claim 1, configured to reduce speed on the basis of weather conditions, illumination or quality of the road surface.

10. System according to claim 1, further comprising an acceleration sensor to supply acceleration information from the vehicle to the control module.

11. Vehicle provided with a system according to claim 1.

12. Method for training a system according to claim 1, comprising:
A. Driving of at least one intended autonomously drivable route by a driver with the controllable self-driving vehicle;
B. Recording camera images of the route during the driving;
C. Storing navigation points in relation to the camera images;
D. Annotating the navigation points with coordinates for the navigation module.

13. Method according to claim 12, comprising the recording of the camera images in a form preprocessed for image recognition.

14. Method according to claim 12, comprising the repetition of step A. under different weather conditions and/or traffic conditions.

15. Method according to claim 12, comprising the recording of a timestamp, steering angle and/or speed during the driving of the route.

16. Method according to claim 12, comprising the offline processing of the recorded camera images.

17. Method according to claim 12, configured to train the one system on the basis of the live camera images recorded by one or more systems of the same type.
